(19) United States
(12) Patent Application Publication
(10) Pub. No.: US 2024/0383755 A1
(43) Pub. Date: Nov. 21, 2024

(54) METHOD AND APPARATUS FOR MANUFACTURING CARBON NANOTUBE ASSEMBLED WIRE

(71) Applicants: SUMITOMO ELECTRIC INDUSTRIES, LTD., Osaka-shi, Osaka (JP); UNIVERSITY OF TSUKUBA, Tsukuba-shi, Ibaraki (JP)

(72) Inventors: Toshihiko FUJIMORI, Osaka-shi (JP); Daiji YAMASHITA, Osaka-shi (JP); Takamasa ONOKI, Osaka-shi (JP); Soichiro OKUBO, Osaka-shi (JP); Takeshi HIKATA, Osaka-shi (JP); Junichi FUJITA, Tsukuba-shi (JP)

(73) Assignees: SUMITOMO ELECTRIC INDUSTRIES, LTD., Osaka-shi, Osaka (JP); UNIVERSITY OF TSUKUBA, Tsukuba-shi, Ibaraki (JP)

(21) Appl. No.: 18/685,830

(22) PCT Filed: Aug. 18, 2022
(86) PCT No.: PCT/JP2022/031197

§ 371 Date: Feb. 22, 2024

(30) Foreign Application Priority Data
Aug. 25, 2021 (JP) 2021-137323

(51) Int. Cl. C01B 32/168; B01J 8/18; C01B 32/162; D01F 9/127; D01F 9/133

(52) U.S. Cl. CPC C01B 32/168; B01J 8/1827; B01J 8/1836; C01B 32/162; D01F 9/1272; D01F 9/133; B01J 2208/065; C01B 2202/22

(57) ABSTRACT

As a method for manufacturing a carbon nanotube assembled wire, that is capable of manufacturing the carbon nanotube assembled wire in a tubular carbon nanotube synthesis furnace efficiently, an adhesion suppressing gas stream is generated from an adhesion suppressing gas discharge port located between a second end of the carbon nanotube synthesis furnace and an end of a heater closer to the second end, the adhesion suppressing gas stream flowing between an internal wall of the carbon nanotube synthesis furnace and an external wall of a first channel, in which carbon nanotubes are oriented to form the carbon nanotube assembled wire, in a direction from the second end toward a first end to suppress adhesion of a plurality of carbon nanotubes to the internal wall of the carbon nanotube synthesis furnace.

### TECHNICAL FIELD

The present disclosure relates to a method and apparatus for manufacturing a carbon nanotube assembled wire. The present application claims priority based on Japanese Patent Application No. 2021-137323 filed on Aug. 25, 2021. The entire contents of the description in this Japanese patent application are incorporated herein by reference.

### BACKGROUND ART

A carbon nanotube (hereinafter also referred to as “CNT”) composed of a cylindrical graphene sheet made of carbon atoms bonded in a hexagonal pattern is a material having a weight (or specific gravity) that is one fifth of that of copper, a strength that is 20 times that of steel, and excellent conductivity. Thus, an electric wire using the carbon nanotube is expected as a material contributing to decreased weight and size and improved corrosion resistance of motors for automobiles in particular.

Currently manufactured carbon nanotubes have a diameter of about 0.4 nm to 20 nm and a maximum length of about 55 cm. In order to use a carbon nanotube as an electric wire, a high strength material and the like, the carbon nanotube needs to be longer wire, and accordingly, techniques using carbon nanotubes to obtain elongated wire have been studied.

For example, International Publication No. 2020/138378 (PTL 1) discloses a method for obtaining an elongated carbon nanotube assembled wire by supplying a carbon-containing gas to catalyst particles suspended in a carbon nanotube synthesis furnace to grow a plurality of carbon nanotubes from the catalyst particles, and orientating the plurality of carbon nanotubes in their longitudinal direction and thus assembling them together.

### CITATION LIST

### Patent Literature

PTL: WO 2020/138378

### SUMMARY OF INVENTION

A method for manufacturing a carbon nanotube assembled wire according to the present disclosure comprises:

a first step of supplying a carbon-containing gas at one, first end of a tubular carbon nanotube synthesis furnace and heating the carbon nanotube synthesis furnace by a heater provided on an outer circumference of the carbon nanotube synthesis furnace to grow a carbon nanotube from each of a plurality of catalyst particles suspended in the carbon nanotube synthesis furnace to synthesize a plurality of carbon nanotubes;

a second step of orienting the plurality of carbon nanotubes in a longitudinal direction of the carbon nanotubes in a first channel provided in the carbon nanotube synthesis furnace, and thus assembling them together, to form the carbon nanotube assembled wire; and

a third step of collecting the carbon nanotube assembled wire at a second end of the carbon nanotube synthesis furnace opposite to the first end,

an adhesion suppressing gas stream being generated from an adhesion suppressing gas discharge port located between the second end and an end of the heater closer to the second end, the adhesion suppressing gas stream flowing between an internal wall of the carbon nanotube synthesis furnace and an external wall of the first channel in a direction from the second end toward the first end to suppress adhesion of the plurality of carbon nanotubes to the internal wall of the carbon nanotube synthesis furnace.

An apparatus for manufacturing a carbon nanotube assembled wire according to the present disclosure comprises:

a tubular carbon nanotube synthesis furnace;

a heater provided on an outer circumference of the carbon nanotube synthesis furnace;

a carbon-containing gas supply port provided at one, first end of the carbon nanotube synthesis furnace;

a first channel provided in the carbon nanotube synthesis furnace; and

an adhesion suppressing gas stream generator having an adhesion suppressing gas discharge port located between a second end of the carbon nanotube synthesis furnace opposite to the first end and an end of the heater closer to the second end,

the adhesion suppressing gas discharge port being located to generate an adhesion suppressing gas stream between an internal wall of the carbon nanotube synthesis furnace and an external wall of the first channel in a direction from the second end toward the first end.

### BRIEF DESCRIPTION OF DRAWINGS

FIG. 1 is a diagram for illustrating a representative configuration example of a carbon nanotube assembled wire manufacturing apparatus according to a second embodiment.

FIG. 2 is a perspective view showing an example of an adhesion suppressing gas stream generator.

FIG. 3 is a perspective view of the FIG. 2 adhesion suppressing gas stream generator, as viewed in the direction of an arrow A1 (or on a left side in FIG. 2).

FIG. 4 is a view of the FIG. 2 adhesion suppressing gas stream generator, as viewed in the direction of an arrow B1 (or on a right side in FIG. 2).

FIG. 5 is a cross section of the FIG. 2 adhesion suppressing gas stream generator taken along a line XI-XI.

FIG. 6 is a perspective view showing another example of the adhesion suppressing gas stream generator.

FIG. 7 is a cross section of the FIG. 6 adhesion suppressing gas stream generator taken along a line XII-XII.

FIG. 8 is a photograph of the interior (of the furnace tube) of the carbon nanotube synthesis furnace after a carbon nanotube assembled wire was manufactured.

### DETAILED DESCRIPTION

### Problem to be Solved by the Present Disclosure

A carbon nanotube assembled wire produced in a carbon nanotube synthesis furnace moves toward the downstream side of the carbon nanotube synthesis furnace along with a stream of a raw material gas. While the carbon nanotube assembled wire thus moves, attempting to increase an amount of thereof manufactured per unit time tends to cause clogging as the carbon nanotube assembled wire adheres to an internal wall of a downstream side of the carbon nanotube synthesis furnace (or near an end of a heater). There is a need for suppression of such clogging in view of increased productivity of carbon nanotube assembled wire.

Accordingly, one object is to provide a method for manufacturing a carbon nanotube assembled wire, that is capable of efficiently manufacturing a carbon nanotube assembled wire in a carbon nanotube synthesis furnace.

Another object is to provide an apparatus for manufacturing a carbon nanotube assembled wire, that is capable of efficiently manufacturing a carbon nanotube assembled wire in a carbon nanotube synthesis furnace.

### Advantageous Effect of the Present Disclosure

According to the present disclosure, a carbon nanotube assembled wire can be efficiently manufactured in a carbon nanotube synthesis furnace.

### Description of Embodiments of the Present Disclosure

First, embodiments of the present disclosure will be specified and described.
(1) The presently disclosed method for manufacturing a carbon nanotube assembled wire comprises:

a first step of supplying a carbon-containing gas at one, first end of a tubular carbon nanotube synthesis furnace and heating the carbon nanotube synthesis furnace by a heater provided on an outer circumference of the carbon nanotube synthesis furnace to grow a carbon nanotube from each of a plurality of catalyst particles suspended in the carbon nanotube synthesis furnace to synthesize a plurality of carbon nanotubes;

a second step of orienting the plurality of carbon nanotubes in a longitudinal direction of the carbon nanotubes in a first channel provided in the carbon nanotube synthesis furnace, and thus assembling them together, to form the carbon nanotube assembled wire; and

a third step of collecting the carbon nanotube assembled wire at a second end of the carbon nanotube synthesis furnace opposite to the first end,

an adhesion suppressing gas stream being generated from an adhesion suppressing gas discharge port located between the second end and an end of the heater closer to the second end, the adhesion suppressing gas stream flowing between an internal wall of the carbon nanotube synthesis furnace and an external wall of the first channel in a direction from the second end toward the first end to suppress adhesion of the plurality of carbon nanotubes to the internal wall of the carbon nanotube synthesis furnace.

According to the present disclosure, an adhesion suppressing gas stream can be generated from an adhesion suppressing gas discharge port to suppress adhesion of a plurality of carbon nanotubes to an internal wall of a carbon nanotube synthesis furnace and hence manufacture a carbon nanotube assembled wire in the carbon nanotube synthesis furnace efficiently.
(2) Preferably, the adhesion suppressing gas stream has a flow velocity equal to or larger than 4 times and equal to or smaller than 10 times a flow velocity of the carbon-containing gas. This can further suppress adhesion of CNTs to the internal wall of the carbon nanotube synthesis furnace.
(3) Preferably, in the third step, a plurality of carbon nanotube assembled wires are oriented in their longitudinal direction and thus assembled together by using a collecting gas stream flowing in a direction away from the carbon nanotube synthesis furnace.

This can provide a stranded wire (or bundle) composed of carbon nanotube assembled wires oriented in their longitudinal direction and thus assembled together.
(4) Preferably, the adhesion suppressing gas stream is generated using an inert gas. This can suppress adhesion of CNTs to the internal wall of the carbon nanotube synthesis furnace while maintaining a quality of the carbon nanotube assembled wire.
(5) The presently disclosed apparatus for manufacturing a carbon nanotube assembled wire comprises:

a tubular carbon nanotube synthesis furnace;

a heater provided on an outer circumference of the carbon nanotube synthesis furnace;

a carbon-containing gas supply port provided at one, first end of the carbon nanotube synthesis furnace;

a first channel provided in the carbon nanotube synthesis furnace; and

an adhesion suppressing gas stream generator having an adhesion suppressing gas discharge port located between a second end of the carbon nanotube synthesis furnace opposite to the first end and an end of the heater closer to the second end,

the adhesion suppressing gas discharge port being located to generate an adhesion suppressing gas stream between an internal wall of the carbon nanotube synthesis furnace and an external wall of the first channel in a direction from the second end toward the first end.

According to the present disclosure, an adhesion suppressing gas stream can be generated from an adhesion suppressing gas discharge port to suppress adhesion of a plurality of carbon nanotubes to an internal wall of a carbon nanotube synthesis furnace and hence manufacture a carbon nanotube assembled wire in the carbon nanotube synthesis furnace efficiently.
(6) Preferably, the adhesion suppressing gas stream generator further includes a through hole configured to allow the first channel to fit thereto.

This enhances hermeticity between the adhesion suppressing gas stream generator and the first channel and suppresses leakage of the adhesion suppressing gas stream. This can further suppress adhesion of CNTs to the internal wall of the carbon nanotube synthesis furnace.
(7) Preferably, the through hole is in the form of a truncated cone. This can further suppress adhesion of CNTs to the internal wall of the carbon nanotube synthesis furnace.
(8) Preferably, the through hole is cylindrical. This can further suppress adhesion of CNTs to the internal wall of the carbon nanotube synthesis furnace.

### Detailed Description of Embodiments of the Present Disclosure

A specific example of the presently disclosed method and apparatus for manufacturing a carbon nanotube assembled wire will now be described below with reference to the drawings. In the drawings of the present disclosure, the same reference numerals designate identical or corresponding parts. In addition, dimensional relations in length, width, thickness, depth, and the like are changed as appropriate for clarity and simplicity of the drawings, and do not necessarily represent actual dimensional relations.

In the present specification, an expression in the form of “A to B” means a range's upper and lower limits (that is, A or more and B or less), and when A is not accompanied by any unit and B is alone accompanied by a unit, A has the same unit as B.

### First Embodiment: Method for Manufacturing Carbon Nanotube Assembled Wire

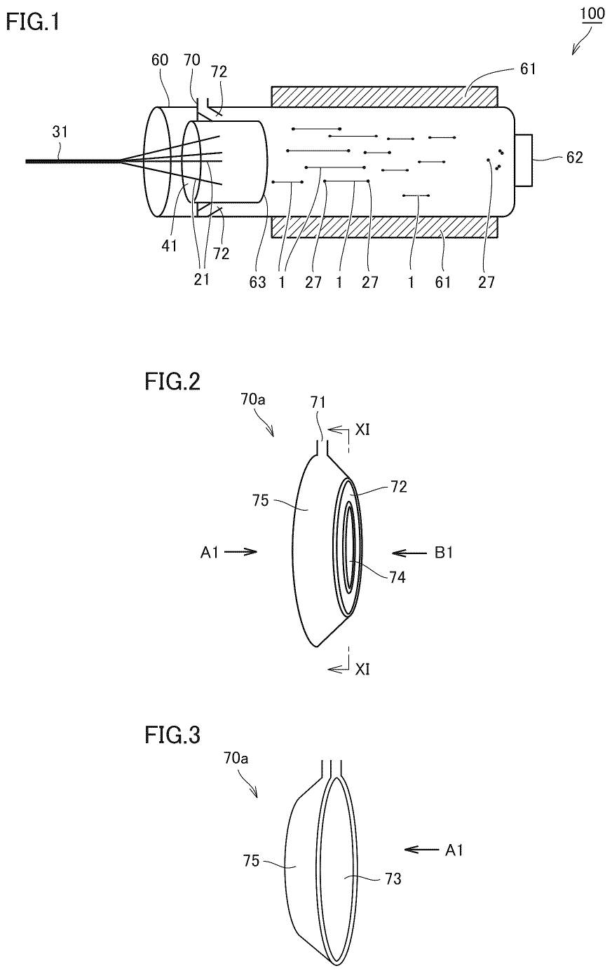

A method for manufacturing a carbon nanotube assembled wire according to one embodiment of the present disclosure (hereinafter also referred to as “the present embodiment”) will now be described with reference to FIG. 1. FIG. 1 shows an example of an apparatus for manufacturing a carbon nanotube assembled wire that is used in the method for manufacturing a carbon nanotube assembled wire according to the present embodiment.

A method for manufacturing a carbon nanotube assembled wire 21 according to the present embodiment comprises:

a first step of supplying a carbon-containing gas at one, first end of a tubular carbon nanotube synthesis furnace 60 (hereinafter also referred to as “CNT synthesis furnace 60”) and heating carbon nanotube synthesis furnace 60 by a heater 61 provided on an outer circumference of carbon nanotube synthesis furnace 60 to grow a carbon nanotube 1 from each of a plurality of catalyst particles 27 suspended in carbon nanotube synthesis furnace 60 to synthesize a plurality of carbon nanotubes 1;

a second step of orienting the plurality of carbon nanotubes 1 in a longitudinal direction of carbon nanotubes 1 in a first channel 41 provided in carbon nanotube synthesis furnace 60, and thus assembling them together, to form carbon nanotube assembled wire 21; and

a third step of collecting carbon nanotube assembled wire 21 at a second end of carbon nanotube synthesis furnace 60 opposite to the first end,

an adhesion suppressing gas stream being generated from an adhesion suppressing gas discharge port 72 located between the second end and an end of heater 61 closer to the second end, the adhesion suppressing gas stream flowing between an internal wall of carbon nanotube synthesis furnace 60 and an external wall of first channel 41 in a direction from the second end toward the first end to suppress adhesion of the plurality of carbon nanotubes 1 to the internal wall of carbon nanotube synthesis furnace 60.

According to the method for manufacturing a carbon nanotube assembled wire according to the present embodiment, an adhesion suppressing gas stream can be generated from an adhesion suppressing gas discharge port to suppress adhesion of a plurality of carbon nanotubes to an internal wall of a carbon nanotube synthesis furnace and hence manufacture a carbon nanotube assembled wire in the carbon nanotube synthesis furnace efficiently.

### First Step

The first step is a step of supplying a carbon-containing gas at one, first end of tubular carbon nanotube synthesis furnace 60 (in FIG. 1, an end thereof provided with a carbon-containing gas supply port 62) and heating carbon nanotube synthesis furnace 60 by heater 61 provided on an outer circumference of carbon nanotube synthesis furnace 60 to grow carbon nanotube 1 from each of a plurality of catalyst particles 27 suspended in carbon nanotube synthesis furnace 60 to synthesize a plurality of carbon nanotubes 1.

The first step is preferably performed under a condition in temperature of 800° C. or higher and 1500° C. or lower for example. Under the condition in temperature of 800° C. or higher and 1500° C. or lower, the carbon-containing gas is thermally decomposed and carbon crystal is grown on the suspended catalyst particles to form carbon nanotubes. Separating a plurality of catalyst particles in close contact with one another in a stream of the carbon-containing gas allows CNTs to be also grown between the plurality of catalyst particles.

Temperature of 800° C. or higher allows carbon crystal to be grown at a higher rate and thus allows increased production efficiency. Temperature of 1500° C. or lower reduces content of impurity carbon and improves CNT in quality. The first step is performed under a condition in temperature more preferably of 900° C. or higher and 1450° C. or lower, and still more preferably 1100°° C. or higher and 1400° C. or lower.

In FIG. 1, catalyst particles 27 are suspended in a vicinity of carbon-containing gas supply port 62 of CNT synthesis furnace 60. Catalyst particles 27 are provided as follows: a catalyst (not shown) disposed in CNT synthesis furnace 60 near carbon-containing gas supply port 62 is heated and disintegrated by wind pressure of the carbon-containing gas to be particles.

Examples of the catalyst include ferrocene (Fe(C₅H₅)₂), nickelocene (Ni(C₅H₅)₂), cobaltocene (Co(C₅ H₅)₂, etc.), and the like. Inter alia, the catalyst particles are preferably ferrocene as it is excellent in disintegrability and catalysis and allows elongate CNT to be obtained. It is believed that, when ferrocene is heated to a high temperature and exposed to the carbon-containing gas, it forms iron carbide (Fe₃C) on a surface thereof through carburization, and is thus disintegratable from the surface to release catalyst particles 27 successively. In this case, a major ingredient of catalyst particles 27 formed will be iron carbide or iron.

Examples of catalyst particles 27 other than the above include nickel, cobalt, molybdenum, gold, silver, copper, palladium, and platinum.

Catalyst particle 27 has an average diameter with a lower limit preferably of 30 nm or more, more preferably 40 nm or more, and still more preferably 50 nm or more. Catalyst particle 27 has the average diameter with an upper limit preferably of 1000 μm or less, more preferably 100 μm or less, and still more preferably 10 μm or less. Catalyst particle 27 having an average diameter of 30 nm or more allows a carbon nanotube formed by the catalyst particle to have an increased diameter and accordingly, be drawn at an increased rate and hence have a sufficient length. The catalyst particle having an average diameter of 1000 μm or less facilitates drawing a carbon nanotubes formed by the catalyst particle.

An average diameter of catalyst particles 27 can be confirmed by observing a manufactured carbon nanotube assembled wire with a transmission electron microscope (TEM). Herein, an “average diameter” of the catalyst particles means a median diameter (d50) in volume-based particle size distribution (volume distribution), and means an average diameter of all catalyst particles included in the carbon nanotube assembled wire. The particle diameter of each particle for calculating the particle diameter (volume average particle diameter) of the catalyst particles included in the carbon nanotube assembled wire can be measured in the following method: Initially, the carbon nanotube assembled wire has any region (measurement field of view: 0.5 μm×0.5 μm) observed with a TEM at a magnification of 100,000 to 500,000 times. Subsequently, in the TEM image, an outer diameter, which is a distance between farthest two points on the outer circumference of each catalyst particle, is measured, and an average value of such outer diameters is calculated.

The carbon-containing gas is supplied through carbon-containing gas supply port 62 to CNT synthesis furnace 60. As the carbon-containing gas, a reducing gas such as hydrocarbon gas is used. Examples of such a carbon-containing gas include a gaseous mixture of methane and argon, a gaseous mixture of ethylene and argon, a gaseous mixture of methane and hydrogen, a gaseous mixture of ethylene and hydrogen, a gaseous mixture of ethanol and argon, and the like. The carbon-containing gas preferably includes carbon disulfide (CS₂) or thiophene (C₄H₄S) as an assistive catalyst.

A lower limit for the flow velocity of the carbon-containing gas is preferably 0.05 cm/sec or more, more preferably 0.10 cm/sec or more, and still more preferably 0.20 cm/sec or more. An upper limit for the flow velocity of the carbon-containing gas is preferably 10.0 cm/sec or less. When the flow velocity of the carbon-containing gas is 0.05 cm/sec or more, catalyst particles 27 are sufficiently supplied with the carbon-containing gas, which facilitates growth of carbon nanotubes synthesized between catalyst particles 27. When the flow velocity of the carbon-containing gas is 10.0 cm/sec or less, it can prevent carbon nanotubes from detaching from catalyst particles 27 and thus stopping their growth. The flow velocity of the carbon-containing gas is preferably 0.05 cm/sec or more and 10.0 cm/sec or less, more preferably 0.10 cm/sec or more and 10.0 cm/sec or less, and still more preferably 0.20 cm/sec or more and 10.0 cm/sec or less. In the present specification, a “flow velocity of the carbon-containing gas” means an average flow velocity of the carbon-containing gas in a region within CNT synthesis furnace 60 between carbon-containing gas supply port 62 and first channel 41.

A lower limit for the Reynolds number of the flow in CNT synthesis furnace 60 of the carbon-containing gas supplied through carbon-containing gas supply port 62 is preferably 0.01 or more, and more preferably 0.05 or more. An upper limit for the Reynolds number is preferably 1000 or less, more preferably 100 or less, still more preferably 10 or less. A Reynolds number of 0.01 or more allows the apparatus to be designed with an increased degree of freedom. A Reynolds number of 1000 or less suppresses a disturbed flow of the carbon-containing gas and hence a disturbed synthesis of carbon nanotubes between catalyst particles 27.

Examples of carbon nanotube 1 obtained through the first step include a single-layer carbon nanotube in which only a single carbon layer (graphene) has a cylindrical shape, a double-layer carbon nanotube or a multilayer carbon nanotube in which a stack of a plurality of carbon layers has a cylindrical shape, and the like.

The shape of the carbon nanotube is not particularly limited, and both a carbon nanotube having closed ends and a carbon nanotube having open ends are included. Further, carbon nanotube 1 may have one or opposite ends with catalyst particle 27, which is used in synthesizing the carbon nanotube, adhering thereto. Further, carbon nanotube 1 may have one or opposite ends with a conical portion formed of conical graphene.

The carbon nanotube has a length preferably of 10 μm or more, more preferably 100 μm or more, for example. In particular, when the carbon nanotube has a length of 100 μm or more, such a length is suitable from the viewpoint of producing the CNT assembled wire. Although an upper limit value for the length of the carbon nanotube is not particularly limited, it is preferably 600 mm or less from the viewpoint of manufacturing. The length of the CNT is preferably 10 μm or more and 600 mm or less, and more preferably 100 μm or more and 600 mm or less. The length of the CNT can be measured through observation with a scanning electron microscope.

The carbon nanotube has a diameter preferably of 0.6 nm or more and 20 nm or less, and more preferably 1 nm or more and 10 nm or less. In particular, when the carbon nanotube has a diameter of 1 nm or more and 10 nm or less, such a diameter is suitable from the viewpoint of heat resistance under an oxidizing condition.

In the present specification, a diameter of a carbon nanotube means an average outer diameter of a single CNT. The CNT's average outer diameter is obtained by directly observing cross sections at any two portions of the CNT with a transmission electron microscope, measuring in each cross section a distance between mutually remotest two points on the outer circumference of the CNT, that is, an outer diameter, and calculating an average value of such obtained outer diameters. When the CNT has one or opposite ends with the conical portion, the diameter is measured at a portion other than the conical portion.

### Second Step

The second step is a step of orienting a plurality of carbon nanotubes 1 that is obtained in the first step in the longitudinal direction of carbon nanotubes 1 in first channel 41 provided in carbon nanotube synthesis furnace 60 and thus assembling the carbon nanotubes together to form carbon nanotube assembled wire 21.

A plurality of CNTs 1 synthesized in CNT synthesis furnace 60 enter first channel 41 with their longitudinal direction along the flow of the carbon-containing gas. First channel 41 is disposed to have its axial direction along the flow of the carbon-containing gas. An area in cross section of first channel 41 to which the flow of the carbon-containing gas is normal is smaller than that in cross section of CNT synthesis furnace 60 to which the flow of the carbon-containing gas is normal. Accordingly, the plurality of CNTs 1 having entered first channel 41 are oriented in the longitudinal direction of the CNTs in first channel 41 and thus assembled together to form CNT assembled wire 21.

The carbon nanotube assembled wire obtained in the second step is in the form of a yarn formed of a plurality of carbon nanotubes oriented in their longitudinal direction and thus assembled together.

The length of the carbon nanotube assembled wire is not particularly limited, and can be adjusted as appropriate depending on the application. A lower limit for the length of the CNT assembled wire is preferably 100 μm or more, more preferably 1000 μm or more, and further preferably 10 cm or more, for example. Although an upper limit for the length of the CNT assembled wire is not particularly limited, it can be 100 cm or less from the viewpoint of manufacturing. The length of the CNT assembled wire is preferably 100 μm or more and 100 cm or less, more preferably 1000 μm or more and 100 cm or less, and still more preferably 10 cm or more and 100 cm or less. The length of the CNT assembled wire is measured through observation with a scanning electron microscope, an optical microscope, or visual observation.

The diameter of the carbon nanotube assembled wire is not particularly limited, and can be adjusted as appropriate depending on the application. A lower limit for the diameter of the CNT assembled wire is, for example, preferably 1 μm or more, more preferably 10 μm or more, still more preferably 100 μm or more, and still more preferably 300 μm or more. Although an upper limit for the diameter of the CNT assembled wire is not particularly limited, it can be 1000 μm or less from the viewpoint of manufacturing. The diameter of the CNT assembled wire is preferably 1 μm or more and 1000 μm or less, more preferably 10 μm or more and 1000 μm or less, still more preferably 100 μm or more and 1000 μm or less, and still more preferably 300 μm or more and 1000 μm or less. In the present embodiment, the diameter of the CNT assembled wire is smaller than the length of the CNT assembled wire. That is, the direction of the length of the CNT assembled wire corresponds to the longitudinal direction. In one aspect of the present embodiment, the CNT assembled wire's cross section is not particularly limited, and it may be circular, generally circular or elliptical.

In the present specification, the diameter of the carbon nanotube assembled wire means an average outer diameter of a single CNT assembled wire. The average outer diameter of a single CNT assembled wire is determined by observing cross sections of any two portions of the CNT assembled wire with a transmission electron microscope or a scanning electron microscope, measuring a distance between mutually remotest two points on the outer circumference of the CNT assembled wire in each cross section, that is, an outer diameter, and calculating an average value of such outer diameters.

It is confirmed through the following procedures (a1) to (a6) that the CNT assembled wire obtained in the present embodiment has a plurality of CNTs oriented in their longitudinal direction and thus assembled together.

### (a1) Imaging CNT Assembled Wire

The CNT assembled wire is imaged using the following instrument under the following conditions.
Transmission electron microscope (TEM): “JEM2100” (product name) manufactured by JEOL Ltd.

Conditions: a magnification of 50,000 times to 1.2 million times, and an acceleration voltage of 60 kV to 200 kV

### (a2) Binarizing the Captured Image

The image captured in the above step (a1) is binarized through the following procedure using the following image processing program.

Image processing program: Non-destructive paper surface fiber orientation analysis program “FiberOri8single03” (http://www.enomae.com/FiberOri/index.htm)

### Processing Procedure

1. Histogram Average Brightness Correction
2. Background Removal
3. Binarization by Single Threshold
4. Brightness Inversion.

### (a3) Fourier Transform of Binarized Image

The image obtained in step (a2) is subjected to Fourier transform using the same image processing program (Non-destructive paper surface fiber orientation analysis program “FiberOri8single03” (http://www.enomae.com/FiberOri/index.htm)).

### (a4) Calculating Degree of Orientation and Intensity of Orientation

In the Fourier-transformed image, with the X-axis having a positive direction represented as 0°, an average amplitude with respect to counterclockwise angle (θ°) is calculated. A relationship between angle of orientation and intensity of orientation obtained from the Fourier-transformed image is graphically represented.

### (a5) Measuring Half Width

Based on the above graphical representation, a full width at half maximum (FWHM) is measured.

### (a6) Calculating Degree of Orientation

Based on the full width at half maximum, degree of orientation is calculated using the following equation (1).

$$degree of orientation = ( 180 ° - full width at half maximum ) / 180 ° \qquad ( 1 )$$

A degree of orientation of 0 means being fully non-oriented. A degree of orientation of 1 means being fully oriented. In the present specification, when the degree of orientation is 0.8 or more and 1.0 or less, it is determined that a CNT assembled wire has a plurality of CNTs oriented in their longitudinal direction and thus assembled together.

When a carbon nanotube assembled wire is composed of carbon nanotubes with a degree of orientation of 0.8 or more and 1.0 or less, the CNT assembled wire is elongated while maintaining characteristics of electric conductivity and mechanical strength that the CNT has.

Note that, as measured by the applicants, it has been confirmed that, insofar as a given, single sample is measured, even when a result of measurement of degree of orientation is calculated a plurality of times while a location where a measurement field of view (having a size of 10 nm×10 nm) is selected is changed, such measurement results thus obtained do not have substantial variation.

### Third Step

The third step is a step of collecting carbon nanotube assembled wire 21 that is obtained in the second step from the second end of carbon nanotube synthesis furnace 60 opposite to the first end.

In one aspect, preferably, in the third step, a plurality of carbon nanotube assembled wires are oriented in their longitudinal direction and thus assembled together by using a collecting gas stream flowing in a direction away from the carbon nanotube synthesis furnace (i.e., a direction away from the first end). This helps moving carbon nanotube assembled wire 21 to the downstream side of CNT synthesis furnace 60 and thus increases efficiency of collecting the CNT assembled wire. Further, the collecting gas stream can suppress deposition of CNTs and CNT assembled wire in the first channel and hence clogging of the first channel due to such deposition. This increases efficiency of collecting the CNT assembled wire.

As a method for orienting a plurality of carbon nanotube assembled wires in their longitudinal direction and thus assembling them together, converging the collecting gas stream toward the downstream side is considered. As the collecting gas stream converges, the plurality of CNT assembled wires approach one another and are thus assembled together to form wire 31 composed of CNT assembled wires stranded together.

While the collecting gas stream's flow velocity is not particularly limited, it is preferably higher than the flow velocity of the carbon-containing gas. This further increases efficiency of collecting the CNT assembled wire.

In the present specification, the “flow velocity of the collecting gas stream” means an average flow velocity of the collecting gas stream passing through a collecting gas discharge port of a collecting gas stream generator (not shown) provided on the side of the second end (or downstream side) of CNT synthesis furnace 60.

While a lower limit for the flow velocity of the collecting gas stream is not particularly limited, it is preferably equal to or larger than 200 times, more preferably equal to or larger than 300 times, and still more preferably equal to or larger than 400 times the flow velocity of the carbon-containing gas from a viewpoint of collecting the CNT assembled wire more efficiently. While an upper limit for the flow velocity of the collecting gas stream is not particularly limited, it can for example be equal to or smaller than 1000 times the flow velocity of the carbon-containing gas. The flow velocity of the collecting gas stream is preferably equal to or larger than 200 times and equal to or smaller than 1000 times, more preferably equal to or larger than 300 times and equal to or smaller than 1000 times, and still more preferably equal to or larger than 400 times and equal to or smaller than 1000 times the flow velocity of the carbon-containing gas.

The lower limit for the flow velocity of the collecting gas stream is preferably 20 m/sec or more, more preferably 30 m/sec or more, and still more preferably 40 m/sec or more. The upper limit for the flow velocity of the collecting gas stream is preferably 100 m/sec or less. The flow velocity of the collecting gas stream is preferably 20 m/sec or more and 100 m/sec or less, more preferably 30 m/sec or more and 100 m/sec or less, and still more preferably 40 m/sec or more and 100 m/sec or less.

Preferably, the collecting gas stream is generated using an inert gas. More specifically, it is preferable to generate on the downstream side of the CNT synthesis furnace a high speed gas stream of the inert gas flowing in a direction away from the CNT synthesis furnace. The high speed gas stream generates a suction force to draw air internal to the CNT synthesis furnace, and thus generates a collecting gas stream flowing from the second end of the CNT synthesis furnace in a direction away from the CNT synthesis furnace. As the collecting gas stream contains a large amount of a component of the inert gas, a reaction between the carbon nanotube assembled wire and the collecting gas stream is less easily caused, and the carbon nanotube assembled wire can be collected more efficiently while a quality of the CNT assembled wire is maintained.

### Adhesion Suppressing Gas Stream

In the present embodiment, an adhesion suppressing gas stream is generated from adhesion suppressing gas discharge port 72 located between the second end and an end of heater 61 closer to the second end, the adhesion suppressing gas stream flowing between an internal wall of carbon nanotube synthesis furnace 60 and an external wall of first channel 41 in a direction from the second end toward the first end to suppress adhesion of the plurality of carbon nanotubes 1 to the internal wall of carbon nanotube synthesis furnace 60. Thus, an adhesion suppressing gas stream can be generated from an adhesion suppressing gas discharge port to suppress adhesion of a plurality of carbon nanotubes to an internal wall of a carbon nanotube synthesis furnace and hence manufacture a carbon nanotube assembled wire in the carbon nanotube synthesis furnace efficiently.

In the present specification, a “flow velocity of the adhesion suppressing gas stream” means an average flow velocity of the adhesion suppressing gas stream passing through adhesion suppressing gas discharge port 72 (see FIG. 2) of an adhesion suppressing gas stream generator 70 provided on the side of the second end (or the downstream side) of CNT synthesis furnace 60.

In one aspect of the present embodiment, the adhesion suppressing gas stream has a flow velocity preferably equal to or larger than 4 times and equal to or smaller than 10 times, more preferably equal to or larger than 5 times and equal to or smaller than 10 times, and still more preferably equal to or larger than 6 times and equal to or smaller than 10 times the flow velocity of the carbon-containing gas. This can further suppress adhesion of CNTs to the internal wall of the carbon nanotube synthesis furnace.

A lower limit for the flow velocity of the adhesion suppressing gas stream is preferably 0.2 cm/sec or more, more preferably 0.5 cm/sec or more, and still more preferably 1.2 cm/sec or more. An upper limit for the flow velocity of the adhesion suppressing gas stream is preferably 100 cm/sec or less. The flow velocity of the adhesion suppressing gas stream is preferably 0.2 cm/sec or more and 100 cm/sec or less, more preferably 0.5 cm/sec or more and 100 cm/sec or less, and still more preferably 1.2 cm/sec or more and 100 cm/sec or less.

Preferably, the adhesion suppressing gas stream is generated using an inert gas. This can suppress adhesion of CNTs to the internal wall of the carbon nanotube synthesis furnace while maintaining a quality of the carbon nanotube assembled wire. The inert gas includes argon gas, helium gas, nitrogen gas, and the like for example.

In one aspect of the present embodiment, an adhesion suppressing gas stream may be generated from adhesion suppressing gas discharge port 72 located between the second end and an end of heater 61 closer to the second end, the adhesion suppressing gas stream flowing along an internal wall of carbon nanotube synthesis furnace 60 in a direction from the second end toward the first end to suppress adhesion of the plurality of carbon nanotubes 1 to the internal wall of carbon nanotube synthesis furnace 60.

### Second Embodiment: Carbon Nanotube Assembled Wire Manufacturing Apparatus

One example of an apparatus for manufacturing a carbon nanotube assembled wire that is used in the method for manufacturing a carbon nanotube assembled wire according to the first embodiment will now be described with reference to FIGS. 1-7.

As shown in FIG. 1, a carbon nanotube assembled wire manufacturing apparatus 100 of the present embodiment comprises tubular carbon nanotube synthesis furnace 60, heater 61 provided on an outer circumference of carbon nanotube synthesis furnace 60, carbon-containing gas supply port 62 provided at one, first end (a right end in FIG. 1) of carbon nanotube synthesis furnace 60, first channel 41 provided in carbon nanotube synthesis furnace 60, and adhesion suppressing gas stream generator 70 having adhesion suppressing gas discharge port 72 located between the second end of carbon nanotube synthesis furnace 60 opposite to the first end (in FIG. 1, a left end) and an end of heater 61 closer to the second end. Adhesion suppressing gas discharge port 72 is disposed to generate an adhesion suppressing gas stream between an internal wall of carbon nanotube synthesis furnace 60 and an external wall of the first channel in a direction from the second end toward the first end.

### Carbon Nanotube Synthesis Furnace

Carbon nanotube synthesis furnace (hereinafter also referred to as a “CNT synthesis furnace”) 60 is in the form of a tube formed of quartz. In CNT synthesis furnace 60, carbon nanotubes 1 are formed on catalyst particles 27 using carbon-containing gas.

Carbon nanotube synthesis furnace 60 is heated with heater 61. When heated, CNT synthesis furnace 60 has an internal temperature preferably of 800° C. or higher to 1500° C. or lower. In order to maintain such a temperature, the carbon-containing gas may be heated and thus supplied through carbon-containing gas supply port 62 into CNT synthesis furnace 60, or the carbon-containing gas may be heated in CNT synthesis furnace 60. In one aspect of the present embodiment, heater 61 in the longitudinal direction has a length smaller than that of carbon nanotube synthesis furnace 60.

The area in cross section of CNT synthesis furnace 60 is not particularly limited insofar as it is of a size allowing first channel 41 to be provided inside the CNT synthesis furnace. A plurality of CNT assembled wires can be manufactured in a single CNT synthesis furnace by appropriately adjusting the area in cross section of CNT synthesis furnace 60 depending on the number of first channels 41 and the area in cross section of first channel 41.

A lower limit for the area in cross section of carbon nanotube synthesis furnace 60 is, for example, preferably 50 mm² or more, more preferably 500 mm² or more, and still more preferably 1500 mm² or more from the view point of more efficiently manufacturing the CNT assembled wire. While an upper limit for the area in cross section of the CNT synthesis furnace is not particularly limited, it can for example be 20000 mm² or less from the view point of manufacturing equipment. The area in cross section of the CNT synthesis furnace is preferably 50 mm² or more and 20000 mm² or less, more preferably 500 mm² or more and 20000 mm² or less, and still more preferably 1500 mm² or more and 20000 mm² or less. In the present specification, the area in cross section of CNT synthesis furnace 60 means an area of a hollow portion of the CNT synthesis furnace in a cross section to which the longitudinal direction (or center line) of the CNT synthesis furnace is normal. In one aspect of the present embodiment, carbon nanotube synthesis furnace 60 is not particularly limited in cross section, and it may be circular, generally circular or elliptical.

### Carbon-Containing Gas Supply Port

Carbon-containing gas supply port 62 is provided at one or first end of carbon nanotube synthesis furnace 60 (a right end thereof in FIG. 1), and the carbon-containing gas is supplied through carbon-containing gas supply port 62 into CNT synthesis furnace 60. A catalyst (not shown) is disposed in CNT synthesis furnace 60 near the carbon-containing gas supply port.

Carbon-containing gas supply port 62 can be configured to have a gas cylinder (not shown) and a flow control valve (not shown). In one aspect of the present embodiment, the gas cylinder and the flow control valve may be coupled to carbon-containing gas supply port 62.

### First Channel

First channel 41 is provided within carbon nanotube synthesis furnace 60. In one aspect of the present embodiment, a first structure 63 having first channel 41 may be provided in carbon nanotube synthesis furnace 60. The first channel is in the form of a tube that is a quartz tube for example. An area in cross section of the first channel is smaller than that in cross section of carbon nanotube synthesis furnace 60. In the first channel, a plurality of carbon nanotubes are oriented in their longitudinal direction and thus assembled together to form a carbon nanotube assembled wire. Furthermore, in the first channel, a tensile force can be applied to the carbon nanotubes in a direction toward the downstream side of the carbon-containing gas. When a tensile force acts on an end of a carbon nanotube, the carbon nanotube is pulled while extending from catalyst particle 27, and thus drawn in the longitudinal direction while it is plastically deformed and reduced in diameter. Thus, a CNT and hence a CNT assembled wire are easily elongated.

The area in cross section of first channel 41 can be set, as appropriate, depending on the desired diameter of the CNT assembled wire. A lower limit for the area in cross section of first channel 41 is preferably 30 mm² or more, more preferably 300 mm² or more, and still more preferably 950 mm² or more from the view point of suppression of clogging by the CNT. An upper limit for the area in cross section of first channel 41 is preferably 13000 mm² or less, more preferably 10000 mm² or less, and still more preferably 5000 mm² or less from the view point of manufacturing the apparatus. The area in cross section of first channel 41 is preferably 30 mm² or more and 13000 mm² or less, more preferably 300 mm² or more and 10000 mm² or less, and still more preferably 950 mm² or more and 5000 mm² or less.

In the present specification, the area in cross section of first channel 41 means an area of the first channel in a cross section to which the center line of the first channel is normal.

First channel 41 is preferably provided at a position apart from the first end of CNT synthesis furnace 60 by 30 cm or more and 500 cm or less. According to this, CNTs flowing into the first channel have an appropriate length, and a CNT assembled wire is easily formed in the first channel. In one aspect of the present embodiment, preferably, first channel 41 is provided closer to the second end than an end of heater 61 (an end thereof closer to the second end) is. Further, in another aspect of the present embodiment, first structure 63 having first channel 41 may be provided closer to the second end than the end of heater 61 (the end thereof closer to the second end) is.

A plurality of first channels 41 may be provided in CNT synthesis furnace 60 in the longitudinal direction of CNT synthesis furnace 60 in parallel. In other words, first structure 63 may have the plurality of first channels 41. This allows single CNT synthesis furnace 60 to produce a plurality of CNT assembled wires 21.

In the present specification, the plurality of first channels 41 being provided in the longitudinal direction of CNT synthesis furnace 60 in parallel means that the center line of each first channel 41 and the longitudinal direction of CNT synthesis furnace 60 form an angle of 0° or more and 5° or less.

The first channel is not limited in number, and one or any larger number of first channels may be used. For example, one or more and 100 or less first channels may be used. For the apparatus for manufacturing a CNT assembled wire according to the present embodiment, the number of first channels provided in parallel may correspond to the number of CNT assembled wires produced. Therefore, the number of CNT assembled wires 21 manufactured using a single CNT synthesis furnace can be increased by increasing the number of first channels provided in parallel.

### Adhesion Suppressing Gas Stream Generator (1)

Adhesion suppressing gas stream generator 70 is provided at the second end (or a left side in FIG. 1) of CNT synthesis furnace 60 opposite to the first end thereof. Adhesion suppressing gas stream generator 70 has adhesion suppressing gas discharge port 72 located between the second end and an end of heater 61 closer to the second end. An example of the adhesion suppressing gas stream generator will be described with reference to FIGS. 2 to 5.

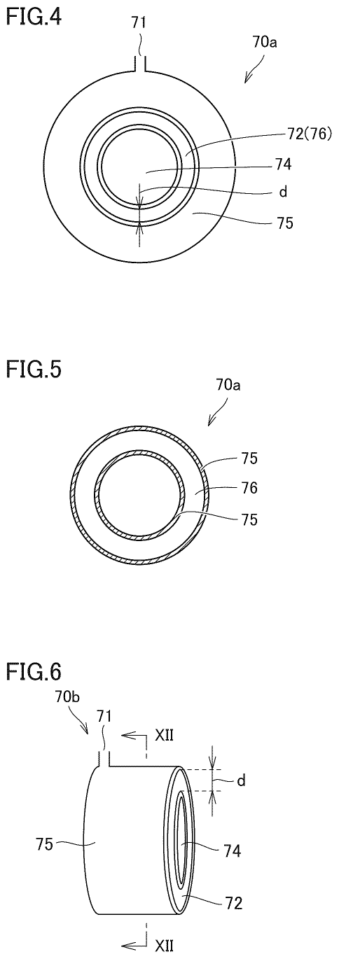

FIG. 2 is a perspective view of an adhesion suppressing gas stream generator 70a. FIG. 3 is a perspective view of the FIG. 2 adhesion suppressing gas stream generator 70a, as viewed in the direction of an arrow A1 (or on a left side in FIG. 2). FIG. 4 is a perspective view of the FIG. 2 adhesion suppressing gas stream generator 70a, as viewed in the direction of an arrow B1 (or on a right side in FIG. 2). FIG. 5 is a cross section of the FIG. 2 adhesion suppressing gas stream generator 70a taken along a line XI-XI. When the adhesion suppressing gas stream generator shown in FIG. 2 is applied to the CNT assembled wire manufacturing apparatus of FIG. 1, the adhesion suppressing gas stream generator is disposed such that a side thereof provided with a second hole 74 faces the first end of CNT synthesis furnace 60.

Adhesion suppressing gas stream generator 70a includes a through hole configured to allow first channel 41 to fit thereto, and adhesion suppressing gas discharge port 72 provided outside (or on a side radially outer than) second hole 74. Adhesion suppressing gas stream generator 70a has the through hole in the form of a truncated cone with first hole 73 as a bottom plane and second hole 74 as a top plane. The through hole is also understood to be a space with first and second holes 73 and 74 as ends. In one aspect of the present embodiment, adhesion suppressing gas stream generator 70a is also understood to be a truncated cone in external appearance.

When an adhesion suppressing gas is discharged from adhesion suppressing gas discharge port 72, the adhesion suppressing gas generates an adhesion suppressing gas stream flowing from the second end toward the first end. The adhesion suppressing gas stream can suppress adhesion of a plurality of carbon nanotubes to an internal wall of the carbon nanotube synthesis furnace.

Preferably, adhesion suppressing gas stream generator 70a includes a second structure 75 having a shape surrounding the through hole, and second structure 75 is provided with an adhesion suppressing gas introduction port 71, adhesion suppressing gas discharge port 72, and an internal channel 76 interconnecting adhesion suppressing gas introduction port 71 and adhesion suppressing gas discharge port 72. This allows the adhesion suppressing gas to be discharged through adhesion suppressing gas discharge port 72 at a controlled flow velocity by introducing the adhesion suppressing gas into adhesion suppressing gas introduction port 71 at a controlled flow velocity. In one aspect of the present embodiment, adhesion suppressing gas stream generator 70a can be configured to have a gas cylinder (not shown) and a flow control valve (not shown). In one aspect of the present embodiment, the gas cylinder and the flow control valve may be coupled to adhesion suppressing gas introduction port 71.

When the adhesion suppressing gas has an increased flow velocity, the adhesion suppressing gas and the carbon-containing gas join and a gas flowing through the first channel flows at an increased flow velocity. A lower limit for the flow velocity of the adhesion suppressing gas is preferably 0.2 cm/sec or more, more preferably 0.5 cm/sec or more, and still more preferably 1.2 cm/sec or more. An upper limit for the flow velocity of the adhesion suppressing gas is preferably 100 cm/sec or less. The flow velocity of the adhesion suppressing gas is preferably 0.2 cm/sec or more and 100 cm/sec or less, more preferably 0.5 cm/sec or more and 100 cm/sec or less, and still more preferably 1.2 cm/sec or more and 100 cm/sec or less.

As shown in FIG. 4, preferably, adhesion suppressing gas discharge port 72 is in the form of a ring having a width d with an upper limit of 4 mm or less. This allows adhesion suppressing gas discharge port 72 to discharge a gas at an increased flow velocity even when the gas is introduced through adhesion suppressing gas introduction port 71 in a small amount. An upper limit for width d is more preferably 1 mm or less, and still more preferably 0.5 mm or less. A lower limit for width d can for example be 0.1 mm or more. Width d is preferably 0.1 mm or more and 4 mm or less, more preferably 0.2 mm or more and 1 mm or less, and still more preferably 0.3 mm or more and 1 mm or less.

The adhesion suppressing gas is preferably made of an inert gas. This prevents an easy reaction between the carbon nanotube assembled wire and the adhesion suppressing gas stream, and allows the carbon nanotube assembled wire to be manufactured more efficiently while a quality of the CNT assembled wire is maintained. The inert gas includes argon gas, helium gas, nitrogen gas, and the like for example.

The FIG. 2 adhesion suppressing gas stream generator 70a has the through hole in the form of a truncated cone with first hole 73 as a bottom plane and second hole 74 as a top plane. Accordingly, the adhesion suppressing gas stream flowing through adhesion suppressing gas discharge port 72 flows to impinge on an external wall of the first channel. This can suppress adhesion of a plurality of carbon nanotubes to the internal wall of the carbon nanotube synthesis furnace, and in addition, can suppress adhesion of the plurality of carbon nanotubes to the external wall of the first channel.

### Adhesion Suppressing Gas Stream Generator (2)

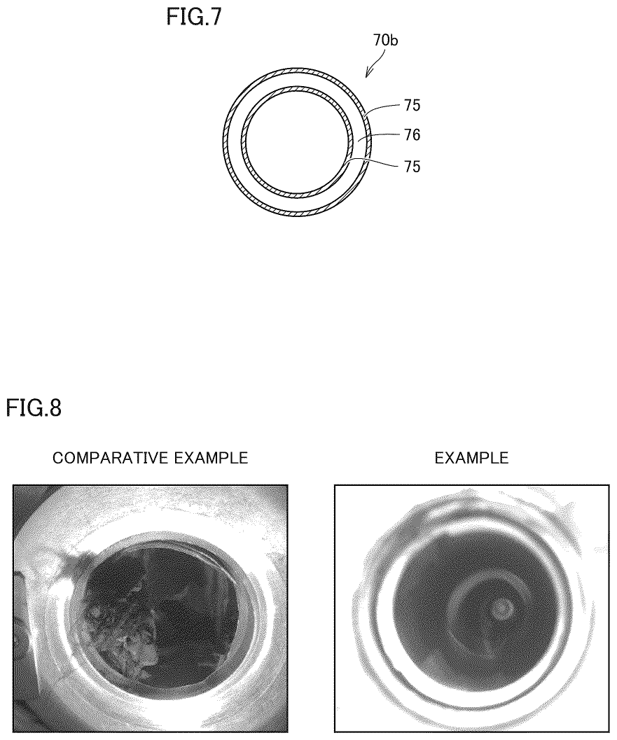

Another example of the adhesion suppressing gas stream generator will be described with reference to FIGS. 6 and 7. FIG. 6 is a perspective view of an adhesion suppressing gas stream generator 70b. FIG. 7 is a cross section of the FIG. 6 adhesion suppressing gas stream generator 70b taken along a line XII-XII. When the adhesion suppressing gas stream generator shown in FIG. 6 is applied to the CNT assembled wire manufacturing apparatus of FIG. 1, the adhesion suppressing gas stream generator is disposed such that a side thereof with second hole 74 faces the first end of CNT synthesis furnace 60.

Adhesion suppressing gas stream generator 70b basically has the same configuration as adhesion suppressing gas stream generator 70a except that the through hole is cylindrical. Furthermore, an adhesion suppressing gas introduced into adhesion suppressing gas stream generator 70b can also be the same in flow velocity and type as that used for adhesion suppressing gas stream generator 70a. In one aspect of the present embodiment, it is also understood that adhesion suppressing gas stream generator 70b is cylindrical in appearance.

Conventionally, carbon nanotubes produced in the carbon nanotube synthesis furnace tend to adhere to an internal wall of the carbon nanotube synthesis furnace between heater 61 and first channel 41 (i.e., a region where the carbon nanotubes are cooled) and thus cause clogging. In the presently disclosed carbon nanotube manufacturing method, when an adhesion suppressing gas is discharged from adhesion suppressing gas discharge port 72, the adhesion suppressing gas generates an adhesion suppressing gas stream in a direction from the second end toward the first end. The adhesion suppressing gas stream allows the adhesion suppressing gas to be efficiently supplied to the region where carbon nanotubes are cooled, and can thus suppress adhesion of a plurality of carbon nanotubes to the internal wall of the carbon nanotube synthesis furnace.

### EXAMPLES

The embodiments will now be described more specifically with reference to examples. Note, however, that the embodiments are not limited by these examples.

### Example 1

As a manufacturing apparatus is prepared a carbon nanotube assembled wire manufacturing apparatus having the same configuration as that shown in FIG. 1. It has a specific configuration as follows:

The manufacturing apparatus comprises: a carbon nanotube synthesis furnace (a quartz tube having a hollow portion with an inner diameter of 41 mm (with an area in cross section of 1320 mm²), and a length 1600 mm); a heater provided on an outer circumference of the carbon nanotube synthesis furnace; a carbon-containing gas supply port provided on one, first end side of the carbon nanotube synthesis furnace (i.e., on a right side in FIG. 1); a first channel (a quartz tube in the form of a cylinder having an outer diameter of 33 mm and a length of 400 mm) provided in the carbon nanotube synthesis furnace; and an adhesion suppressing gas stream generator provided on a side closer to the second end of the carbon nanotube synthesis furnace (i.e., on a left side in FIG. 1 between the second end and the heater).

The first channel is provided in the longitudinal direction of the carbon nanotube synthesis furnace. A distance from an end of the CNT synthesis furnace closer to the carbon-containing gas supply port to an end of the first channel closer to the carbon-containing gas supply port is set to 1500 mm. A catalyst (ferrocene) is disposed in the CNT synthesis furnace near the carbon-containing gas supply port.

The adhesion suppressing gas stream generator has the configuration of the adhesion suppressing gas stream generator shown in FIG. 2, and has a through hole in the form of a truncated cone. The first hole (or the bottom plane of the truncated cone) is a circle with a diameter of 38 mm. The second hole (or the top plane of the truncated cone) is a circle with a diameter of 33 mm. The through hole has an axial length (or the truncated cone has a height) of 30 mm. The adhesion suppressing gas discharge port is in the form of a ring with width d of 4 mm. The adhesion suppressing gas stream generator has a second structure provided with an internal channel interconnecting the adhesion suppressing gas introduction port and the adhesion suppressing gas discharge port.

The above manufacturing apparatus is used to produce a carbon nanotube assembled wire and a wire composed of such carbon nanotube assembled wires stranded together for a sample 1. In the above manufacturing apparatus, the temperature inside an electric furnace (or the heater) is raised to 1400° C. while an argon gas having an argon gas concentration of 100% by volume is supplied through the carbon-containing gas supply port into the CNT synthesis furnace at a flow rate of 1000 cc/min (flow velocity: 3.4 cm/sec) for 50 minutes. Subsequently, the argon gas is stopped, and hydrogen gas is supplied at a flow rate of 7000 cc/min (flow velocity: 8.84 cm/sec), methane gas is supplied at a flow rate of 50 cc/min (flow velocity: 0.17 cm/sec), and carbon disulfide (CS₂) gas is supplied at a flow rate of 1 cc/min (flow velocity: 0.003 cm/sec) for 120 minutes. A gaseous mixture including the argon gas, the methane gas, and the carbon disulfide (i.e., the carbon-containing gas) as a whole has a flow velocity of 9.0 cm/sec.

By supplying the hydrogen gas, the methane gas, and the carbon disulfide gas, a catalyst is disintegrated and catalyst particles are discharged into the CNT synthesis furnace. Subsequently, CNTs are grown in the CNT synthesis furnace and assembled together in the first channel to form a CNT assembled wire.

By introducing an inert gas composed of argon through the adhesion suppressing gas introduction port at a flow rate of 16000 cc/min (flow velocity: 57 cm/sec), the adhesion suppressing gas is discharged through the adhesion suppressing gas discharge port. The adhesion suppressing gas is discharged as synthesis of carbon nanotubes starts.

A gas stream is generated by the adhesion suppressing gas discharged from the adhesion suppressing gas discharge port to suppress adhesion of a plurality of carbon nanotubes to an internal wall of the carbon nanotube synthesis furnace (an internal wall near a terminal end of the heater). When this is compared with synthesizing a carbon nanotube without using the adhesion suppressing gas stream generator (or synthesizing it in a conventional method), the former allows an increased amount of carbon nanotubes to flow into the first channel and hence a carbon nanotube assembled wire to be efficiently manufactured in the carbon nanotube synthesis furnace.

FIG. 8 is a photograph of the interior (of the furnace tube) of the carbon nanotube synthesis furnace after a carbon nanotube assembled wire was manufactured. When the above manufacturing apparatus is used, and synthesizing carbon nanotubes without discharging the adhesion suppressing gas (a comparative example) is compared with synthesizing carbon nanotubes while discharging the adhesion suppressing gas (an example), it can be seen that the latter suppresses clogging of carbon nanotubes inside the carbon nanotube synthesis furnace more than the former.

While embodiments and examples of the present disclosure have been described as above, it is also planned from the beginning that the configurations of the above-described embodiments and examples are appropriately combined and variously modified. The presently disclosed embodiments and examples are illustrative in any respects and should not be construed as being restrictive. The scope of the present invention is defined by the scope of the claims, rather than the embodiments and the examples described above, and is intended to include any modifications within the scope and meaning equivalent to the scope of the claims.

### REFERENCE SIGNS LIST

1 carbon nanotube, 21 carbon nanotube assembled wire, 27 catalyst particle, 31 wire composed of carbon nanotube assembled wires stranded together, 41 first channel, 60 carbon nanotube synthesis furnace, 61 heater, 62 carbon-containing gas supply port, 63 first structure, 70, 70a, 70b adhesion suppressing gas stream generator, 71 adhesion suppressing gas introduction port, 72 adhesion suppressing gas discharge port, 73 first hole, 74 second hole, 75 second structure, 76 internal channel, 100 carbon nanotube assembled wire manufacturing apparatus.

1. A method for manufacturing a carbon nanotube assembled wire, comprising:
a first step of supplying a carbon-containing gas at one, first end of a tubular carbon nanotube synthesis furnace and heating the carbon nanotube synthesis furnace by a heater provided on an outer circumference of the carbon nanotube synthesis furnace to grow a carbon nanotube from each of a plurality of catalyst particles suspended in the carbon nanotube synthesis furnace to synthesize a plurality of carbon nanotubes;
a second step of orienting the plurality of carbon nanotubes in a longitudinal direction of the carbon nanotubes in a first channel provided in the carbon nanotube synthesis furnace, and thus assembling them together, to form the carbon nanotube assembled wire; and
a third step of collecting the carbon nanotube assembled wire at a second end of the carbon nanotube synthesis furnace opposite to the first end,
an adhesion suppressing gas stream being generated from an adhesion suppressing gas discharge port located between the second end and an end of the heater closer to the second end, the adhesion suppressing gas stream flowing between an internal wall of the carbon nanotube synthesis furnace and an external wall of the first channel in a direction from the second end toward the first end to suppress adhesion of the plurality of carbon nanotubes to the internal wall of the carbon nanotube synthesis furnace.

2. The method for manufacturing a carbon nanotube assembled wire according to claim 1, wherein the adhesion suppressing gas stream has a flow velocity equal to or larger than 4 times and equal to or smaller than 10 times a flow velocity of the carbon-containing gas.

3. The method for manufacturing a carbon nanotube assembled wire according to claim 1, wherein in the third step, a plurality of carbon nanotube assembled wires are oriented in their longitudinal direction and thus assembled together by using a collecting gas stream flowing in a direction away from the carbon nanotube synthesis furnace.

4. The method for manufacturing a carbon nanotube assembled wire according to claim 1, wherein the adhesion suppressing gas stream is generated using an inert gas.

5. An apparatus for manufacturing a carbon nanotube assembled wire, comprising:
a tubular carbon nanotube synthesis furnace;
a heater provided on an outer circumference of the carbon nanotube synthesis furnace;
a carbon-containing gas supply port provided at one, first end of the carbon nanotube synthesis furnace;
a first channel provided in the carbon nanotube synthesis furnace; and
an adhesion suppressing gas stream generator having an adhesion suppressing gas discharge port located between a second end of the carbon nanotube synthesis furnace opposite to the first end and an end of the heater closer to the second end,
the adhesion suppressing gas discharge port being located to generate an adhesion suppressing gas stream between an internal wall of the carbon nanotube synthesis furnace and an external wall of the first channel in a direction from the second end toward the first end.

6. The apparatus for manufacturing a carbon nanotube assembled wire according to claim 5, wherein the adhesion suppressing gas stream generator further includes a through hole allowing the first channel to fit thereto.

7. The apparatus for manufacturing a carbon nanotube assembled wire according to claim 6, wherein the through hole is in a form of a truncated cone.

8. The apparatus for manufacturing a carbon nanotube assembled wire according to claim 6, wherein the through hole is cylindrical.
